(19) United States
(12) Patent Application Publication
(10) Pub. No.: US 2015/0118047 A1
(43) Pub. Date: Apr. 30, 2015

(54) WIND TURBINE AND METHOD FOR DETERMINING PARAMETERS OF WIND TURBINE

(71) Applicants: Ken Yoon, Greer, SC (US); Brandon Shane Gerber, Charleston, SC (US); Lisa Kamdar Ammann, Simpsonville, SC (US); Hai Qiu, Shanghai (CN); Yong Yang, Shanghai (CN); Zhilin Wu, Shanghai (CN); Xu Fu, Shanghai (CN); Lihan He, Shanghai (CN); Na Ni, Shanghai (CN); Qiang Li, Shanghai (CN)

(72) Inventors: Ken Yoon, Greer, SC (US); Brandon Shane Gerber, Charleston, SC (US); Lisa Kamdar Ammann, Simpsonville, SC (US); Hai Qiu, Shanghai (CN); Yong Yang, Shanghai (CN); Zhilin Wu, Shanghai (CN); Xu Fu, Shanghai (CN); Lihan He, Shanghai (CN); Na Ni, Shanghai (CN); Qiang Li, Shanghai (CN)

(21) Appl. No.: 14/370,234

(22) PCT Filed: Jan. 27, 2012
(86) PCT No.: PCT/CN2012/070724

§ 371 Date: Jul. 2, 2014

(51) Int. Cl. F03D 11/00; F03D 7/04; F03D 7/02

(52) U.S. Cl. CPC F03D 11/0091; F03D 7/0204; F03D 7/0224; F03D 7/048; F03D 7/044; F03D 7/046; F03D 7/045; F03D 7/0264; F03D 7/0244; F03D 11/0025
USPC 416/1; 416/61; 73/514.01; 702/33

(57) ABSTRACT

A method for determining parameters of a wind turbine is disclosed. The method may generally include receiving signals from at least one Micro Inertial Measurement Unit (MIMU) mounted on or within a component of the wind turbine and determining at least one parameter of the wind turbine based on the signals received from the at least one MIMU.

### RELATED APPLICATIONS

This application claims priority to Application Number 201110141198.1, entitled “Wind Turbine and Method for Determining Parameters of Wind Turbine,” filed in the Chinese Patent Office on May 27, 2011, the disclosure of which is hereby incorporated by reference herein for all purposes.

### FIELD OF THE INVENTION

The present subject matter relates generally to wind turbines and, more particularly, to the use of Micro Inertial Measurement Unit (MIMU) sensors to determine parameters of a wind turbine.

### BACKGROUND OF THE INVENTION

Wind turbines are complex machines, which convert kinetic energy in wind into electrical power energy. When a wind turbine is operated, some parameters of the wind turbine, such as blade pitch, blade rotating speed, yaw, rotor speed, generator speed, and structural vibration, need to be monitored for controlling the wind turbine be more reliable.

In order to monitor the parameters of the wind turbine, different kinds of sensors are mounted to the wind turbine. For example, a rotary encoder is used to detect the blade pitch, blade rotating speed, yaw, rotor speed, and generator speed; an accelerometer is used to monitor the wind turbine vibration; while other sensors, such as ultrasonic sensors, laser sensors, radar sensors, are used to measure other kinds of parameters. Thus, numerous kinds of sensors or meters need to be installed on the wind turbine to monitor the various parameters, which makes the wind turbine be very complicated and very expensive.

Furthermore, the conventional wind turbine can only monitor limited parameters. Parameters, such as torque, thrust, blade bending moment, blade twisting moment, tip displacement, tower bending moment, and three-dimensional motion track, cannot be monitored.

For these and other reasons, there is a need for embodiments of the invention.

### BRIEF DESCRIPTION OF THE INVENTION

Aspects and advantages of the invention will be set forth in part in the following description, or may be obvious from the description, or may be learned through practice of the invention.

In one aspect, the present subject matter discloses a method for determining parameters of a wind turbine. The method may generally include receiving signals from at least one Micro Inertial Measurement Unit (MIMU) mounted on or within a component of the wind turbine and determining at least one parameter of the wind turbine based on the signals received from the at least one MIMU.

In another aspect, the present subject matter discloses a method for determining tip displacement of a wind turbine. The method may generally include receiving signals from at least one Micro Inertial Measurement Unit (MIMU) mounted on or within at least one rotor blade of the wind turbine and determining a tip displacement of the at least one rotor blade based on the signals received from the at least one MIMU.

In a further aspect, the present subject matter discloses a wind turbine. The wind turbine may generally include a tower, a nacelle mounted on top of the tower and a rotor coupled to the nacelle. The rotor may include a shaft, a hub and a plurality of blades extending from the hub. In addition, the wind turbine may include at least one Micro Inertial Measurement Unit (MIMU) mounted on or within at least one of the tower, the nacelle, the hub, the shaft and the plurality of rotor blades. The at least one MIMU may be configured to sense at least one parameter of the wind turbine.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

These and other features and aspects of embodiments of the present invention will become better understood when the following detailed description is read with reference to the accompanying drawings in which like characters represent like parts throughout the drawings, wherein:

FIG. 1 is a schematic view of a wind turbine according to one embodiment.

FIG. 2 is a side view of the wind turbine of FIG. 1.

FIG. 3 is a block diagram of a parameter processing device according to an embodiment.

FIG. 4 is a flowchart of a method for determining parameters of a wind turbine according to one embodiment.

FIG. 5 is a schematic view of a wind turbine according to another embodiment.

FIG. 6 is a side view of a wind turbine according to a further embodiment.

FIG. 7 is a cross-sectional view of one of the rotor blades of the wind turbine of FIG. 6 taken at line 7-7.

FIG. 8 is a perspective, internal view of a nacelle and a hub of a wind turbine according to one embodiment.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Embodiments of the invention relate to a wind turbine including multiple Micro Inertial Measurement Units (MIMUs) mounted at various locations of the wind turbine to monitor the status of the wind turbine. For example, MIMUs mounted on each of the blades of the wind turbine sense parameter signals of the blades, and supply these signals to a parameter processing unit. The parameter processing unit determines parameters of the blades according to the sensed parameter signals.

In addition, embodiments of the present subject matter relate to controlling a wind turbine based on the wind turbine parameters. Specifically, in several embodiments, a controller may be configured to control one or more components of the wind turbine based on the parameters determined by the parameter processing unit. For example, in the event that a tip deflection of one or more of the rotor blades exceeds a predetermined threshold, the controller may be configured to perform one or more corrective actions (e.g., pitching the rotor blades, yawing the nacelle and/or the like) in order to reduce tip deflection and prevent a tower strike.

It should be appreciated that the present subject matter may generally provide numerous advantages for operating a wind turbine. For example, by permitting real-time monitoring and control of the tip deflection of the rotor blades, longer blades may be installed on a wind turbine (e.g., by initially installing longer rotor blades on a wind turbine or by installing blade extensions on existing rotor blades of a wind turbine). As is generally understood, longer blades may improve the overall performance of a wind turbine by increasing its annual energy production (AEP). Moreover, real-time monitoring of wind turbine parameters may lead to an overall reduction in operational and maintenance costs. For instance, monitoring specific wind turbine parameters over time may allow for the development of a set of baseline operating conditions for each wind turbine. As such, wind turbine parameters may be monitored in order to detect variations from these baseline conditions (e.g., due to blade anomalies, blade fatigue, blade fouling, blade icing, and/or the like), which may allow for more accurate scheduling of preventative and/or condition-based maintenance. In addition, real-time monitoring of the wind turbine parameters may also allow for the detection of specific operating conditions, such as asymmetric loading on the blades. For instance, by monitoring the tip deflection of each rotor blade, load imbalances may be detected and subsequently corrected (e.g., by performing a suitable corrective action, such as independently adjusting the pitch angle of one or more of the rotor blades).

Unless defined otherwise, technical and scientific terms used herein have the same meaning as is commonly understood by one of ordinary skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items, and terms such as “front”, “back”, “bottom”, and/or “top”, unless otherwise noted, are merely used for convenience of description, and are not limited to any one position or spatial orientation. Moreover, the terms “coupled” and “connected” are not intended to distinguish between a direct or indirect coupling/connection between two components. Rather, such components may be directly or indirectly coupled/connected unless otherwise indicated.

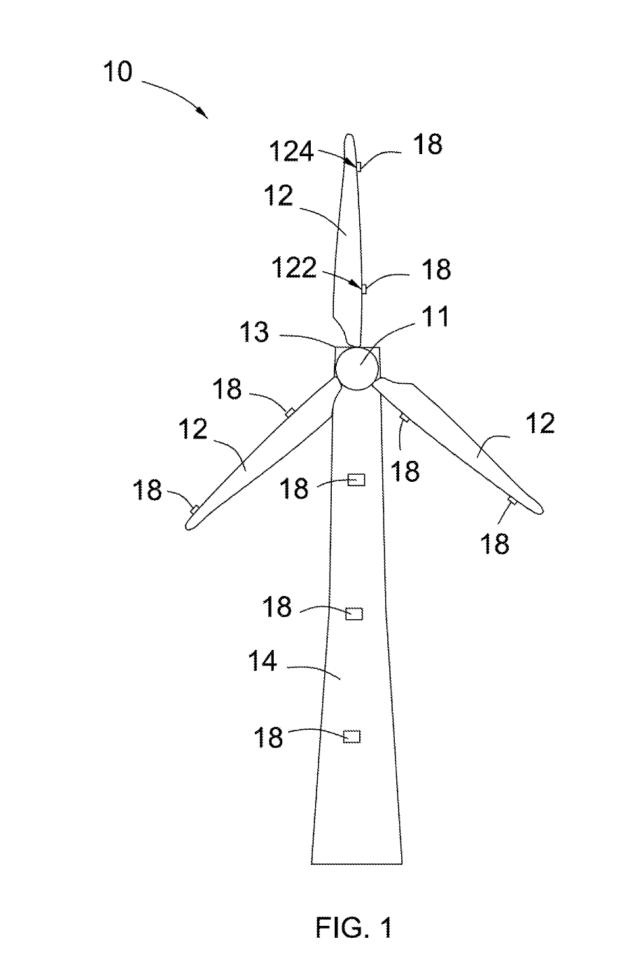

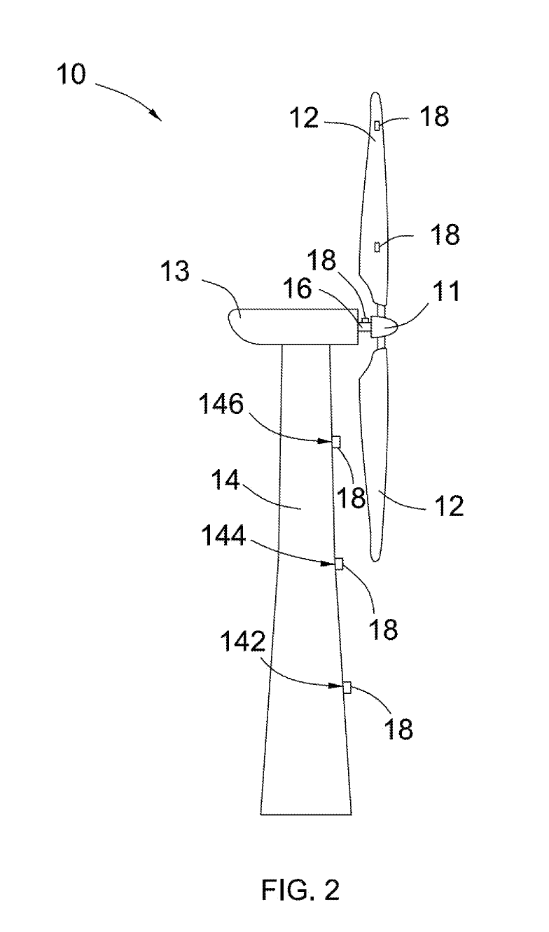

Referring to FIGS. 1 and 2, a wind turbine 10 according to one embodiment includes three blades 12, a tower 14, and a main shaft 16. The wind turbine 10 may also include a hub 11, a nacelle 13, a generator (not shown), and so on, which are conventional technology and, thus, not described here. In other embodiments, the number of the blades 12 may be two or more than three.

In the illustrated embodiment of FIGS. 1 and 2, each blade 12 includes two Micro Inertial Measurement Units (MIMUs) 18 respectively mounted on a root point 122 and a tip point 124 of the corresponding blade 12. The tower 14 comprises three MIMUs 18 respectively mounted on a base point 142, a middle point 144, and a top point 146 of the tower 14. The main shaft 16 comprises an MIMU 18 mounted thereon.

In the illustrated embodiment of FIG. 1, the MIMUs 18 are mounted on external walls of the blades 12, the tower 14, and the main shaft 16. In other embodiments, the MIMUs 18 can be mounted on inner walls of the blades 12, the tower 14, and the main shaft 16, or the MIMUs 18 can be embedded in the walls thereof according to requirements. In other embodiments, the number and the mounted position of the MIMUs 18 can be adjusted according to requirements of desired application or for desired results. For example, each blade 12 can include three or more MIMUs 18 mounted at different positions of the corresponding blades 12. In other embodiments, other parts of the wind turbine 10, such as the hub 11 and the nacelle 13 also include MIMUs 18 to provide parameter signals as necessary.

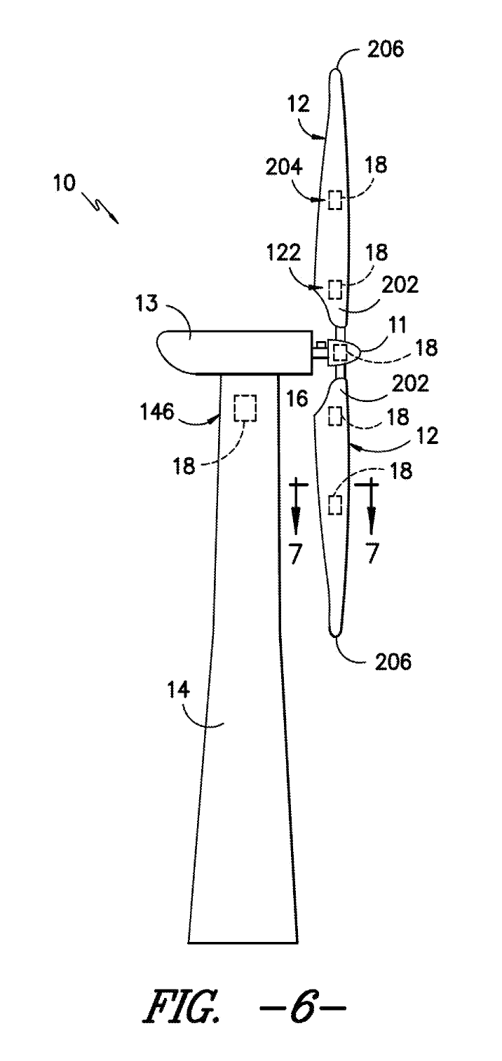

It should be appreciated that, as indicated above, the number and mounted position of each of the MIMUs 18 may be varied. For example, FIG. 6 illustrates a side view of a wind turbine 10 according to another embodiment. As shown in FIG. 6, the wind turbine 10 includes a single MIMU 18 disposed at the top point 146 of the tower 14, such as by mounting the MIMU 18 on or within the tower 14 at a location generally adjacent to the point at which the tower 14 intersects the nacelle 13. Additionally, in one embodiment, the wind turbine 10 may include a MIMU 18 mounted on or within the hub 11 of the wind turbine 10. Moreover, as shown in FIG. 6, in one embodiment, each rotor blade 12 may include one or more MIMUs 18 mounted at the root point 122 of the rotor blades 12 (e.g., by mounting the MIMUs 18 on or within a blade root 202 of each rotor blade 12) and one or more MIMUs 18 mounted at a middle portion 204 of the rotor blades 12, such as at a midpoint between the blade root 202 and a blade tip 206 of each rotor blade 12 or at any other suitable location between the blade root 202 and the blade tip 206. However, in alternative embodiments, the MIMUs 18 may be disposed at any other suitable location on and/or within any suitable component of the wind turbine 10.

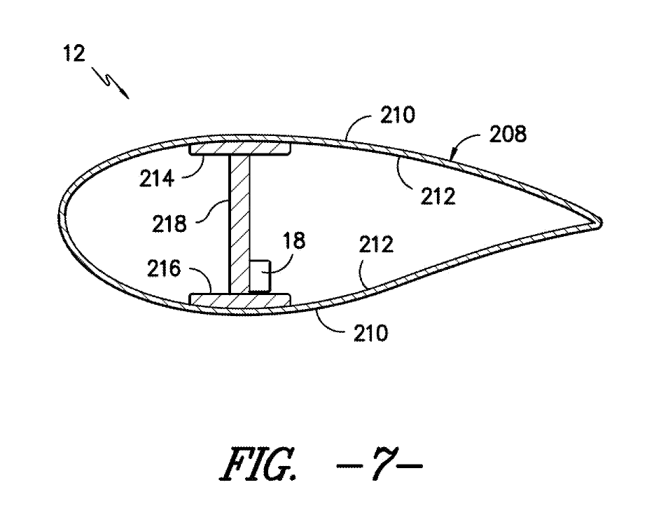

Additionally, it should be appreciated that, in embodiments in which one or more of the MIMUs 18 are mounted within one or more of the rotor blades 12, the MIMU(s) 18 may generally be mounted to any suitable inner wall of the rotor blade(s) 12. For example, FIG. 7 illustrates a cross-sectional view of one embodiment of a rotor blade 12. As shown, the rotor blade 12 generally comprises a hollow body formed from an outer skin or shell 208. The shell 208 may generally have an outer surface 210 defining the outer perimeter of the rotor blade 12 (e.g., by defining pressure and suction sides of the rotor blade 12 that extend between corresponding leading and trailing edges of the rotor blade 12) and an inner surface 212 defining the inner perimeter of the rotor blade 12. In addition, the rotor blade 12 may include structural components 214, 216, 218 disposed within the shell 208. For example, in the illustrated embodiment, the rotor blade 12 includes a first spar cap 214 disposed adjacent to the inner surface 212 of one side of the shell 208, a second spar cap 216 disposed adjacent to the inner surface 212 of the opposing side of the shell 208 and a shear web 218 extending between the first and second spar caps 214, 216. In such an embodiment, any MIMU(s) 18 disposed within the rotor blade 12 may be mounted to one or both of the spar caps 214, 216 or the shear web 218. For example, as shown in FIG. 7, a MIMU 18 may be mounted to the shear web 218 generally adjacent to the intersection between the shear web 218 and one of the spar caps 214, 216. However, in other embodiments, the MIMU(s) 18 may be mounted to any other suitable inner wall of the rotor blade 12, such as by being mounted to the inner surface 212 of the shell 208 or any other surface defined within the rotor blade 12.

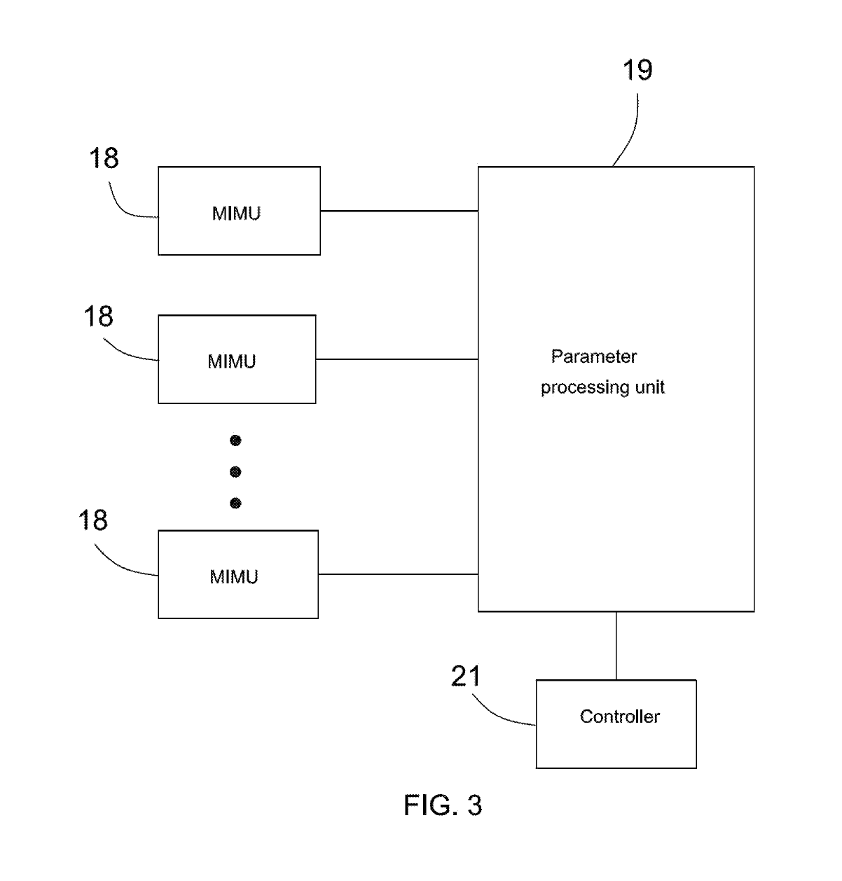

Referring to FIG. 3, the wind turbine 10 further includes a parameter processing unit 19 coupled to all of the MIMUs 18. The parameter process unit 19 may be arranged in the tower 14, the nacelle 13, or in another location according to requirements. The communication mode between the parameter processing unit 19 and the MIMUs 18 can be wireless communication mode or cable communication mode. For example, the MIMUs 18 may be respectively coupled to first wireless transceivers, and the parameter processing unit 19 may be coupled to a second wireless transceiver, thus the MIMUs 18 can communicate with the parameter processing 19 through the first and second wireless transceivers. In one embodiment, the parameter processing unit 19 may be a computer system or a microprocessor system, for example. The parameter processing unit 19 is also coupled to a controller 21 used to receive the parameter signals from the parameter processing unit 19 and control the wind turbine 10 accordingly. In other embodiments, the parameter processing unit 19 and the controller 21 can be integrated as necessary.

It should be appreciated that, as indicated above, the parameter processing unit 19 may generally comprise any suitable computer system, microprocessor system, data acquisition system and/or any other suitable processing unit capable of performing the functions described herein. Similarly, the controller 21 may generally be configured as a turbine controller (e.g., a controller configured to control the operation of a single wind turbine 10) or a farm controller (e.g., a controller configured to control the operation of a plurality of wind turbines 10) and, thus, may comprise any suitable computer system, microprocessor system, and/or any other suitable processing unit capable of performing the functions described herein. For example, in several embodiments, the parameter processing unit 19 and/or the controller 21 may include one or more processor(s) (not shown) and associated memory device(s) (not shown) configured to perform a variety of computer-implemented functions (e.g., performing the methods, steps, operations, calculations and/or the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) of the parameter processing unit 19 and/or the controller 21 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) may generally be configured to store suitable computer-readable instructions that, when implemented by the processor(s), configure the parameter processing unit 19 and/or the controller 21 to perform various functions including, but not limited to, receiving and/or analyzing sensed parameter signals corresponding to measurements transmitted from the MIMUs 18, determining operating parameters of the wind turbine 10 based on the sensed parameter signals, and/or controlling one or more components of the wind turbine 10 based on the determining operating parameters. The memory device(s) may also be used to store temporary input and output variables and other immediate information during execution by the processor(s) of the computer-readable instructions.

Additionally, it should be appreciated that the parameter processing unit 19 and/or the controller 21 may also include a communications module (not shown) to facilitate communication between the parameter processing unit 19 and the controller 21 and/or between such device(s) 19, 21 and the various components of the wind turbine 10. For instance, in several embodiments, the communications module of the parameter processing unit 19 and/or the controller 21 may include a sensor interface (e.g., one or more analog-to-digital converters) configured to permit the MIMUs 18 to transmit sensed parameter signals to the parameter processing unit 19 and/or the controller 21 for subsequent analysis and/or processing.

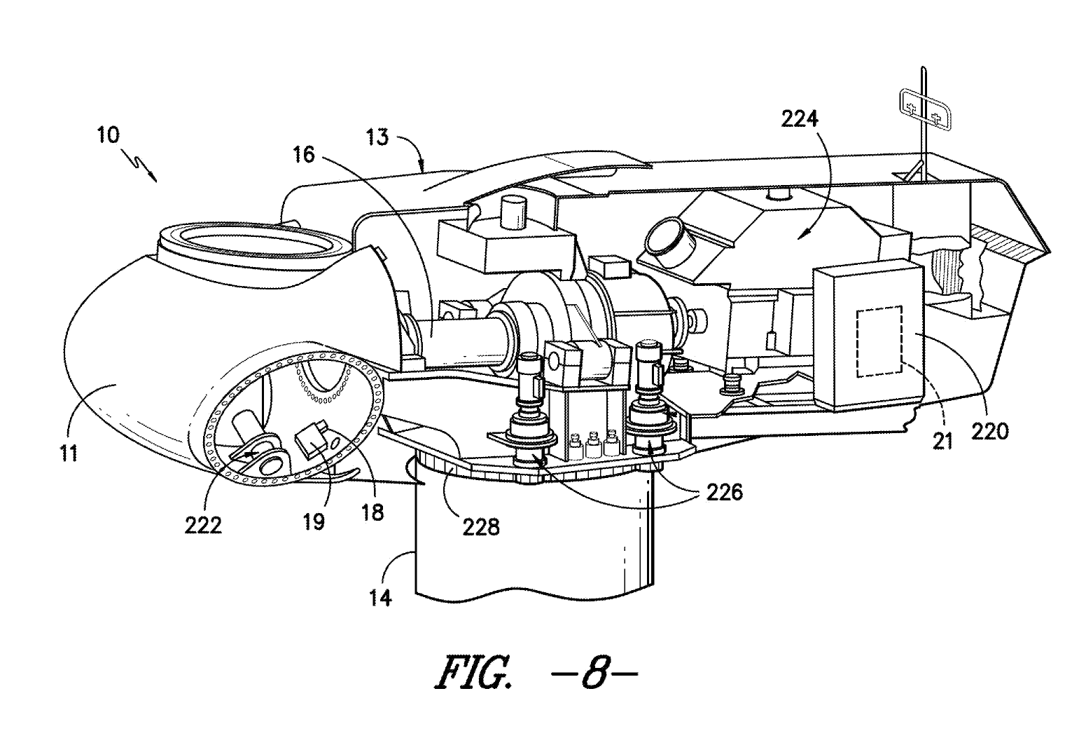

Moreover, the parameter processing unit 19 and/or the controller 21 may generally be located at any suitable location on, within and/or relative to the wind turbine 10. For example, as indicated above, in several embodiments, the parameter processing unit 19 may be located within the tower 14 or the nacelle 13 of the wind turbine 10. In another embodiment, shown in FIG. 8, the parameter processing unit 19 may be disposed within the hub 11 of the wind turbine 10. Such an embodiment may be desirable when one or more of the MIMUs 18 are mounted on or within one or more of the blades 12 to allow the MIMUs 18 to be quickly and easily communicatively coupled to the parameter processing unit 19 via a wired or wireless connection. In addition, as shown in FIG. 8, in embodiments in which the parameter processing unit 19 is disposed within the hub 11, one or more MIMUs 18 may be mounted within the hub, such as at or adjacent to the parameter processing unit 19, to permit additional data to be gathered regarding the rotation, vibration and/or the like of the hub 11.

Similarly, in one embodiment, the controller 21 may be disposed within the nacelle 13 of the wind turbine 10. For example, as shown in FIG. 8, the controller 21 may be positioned within a control cabinet 220 mounted to a portion of the nacelle 13. However, in other embodiments, the controller 21 may be disposed at any other suitable location on or within the wind turbine 10, such as by being disposed within the hub 11 or the tower 14 of the wind turbine 10. Moreover, as indicated above, in several embodiments, the controller 21 may comprise a farm controller configured to control a plurality of wind turbines 10. In such embodiments, it should be appreciated that the controller 21 may be disposed at a remote location relative to the wind turbine 10.

The MIMUs 18 are used to sense parameter signals of the corresponding mounted position of the wind turbine 10. The MIMU is a comprehensive motion capture sensing apparatus, which can sense three dimensional (3D) orientation (pitch, roll, yaw) signals, as well as 3D acceleration signals, 3D rate of turn signals, 3D magnetic field signals, and other related parameter signals in real time according to different kinds of MIMUs. In certain embodiments, the MIMU 18 may include a 3D accelerometer, a 3D gyroscope, and a 3D magnetometer at the same time, or include two kinds of them, or include one kind of them. The parameter processing unit 19 receives the sensed parameter signals from all of the MIMUs 18 and determines parameters of the wind turbine 10 by implementing an embedded model-based estimation program therein.

According to an embodiment, the determined parameters can include blade pitch, blade rotating speed, structural vibration, blade bending moment, blade twisting moment, tip displacement, three dimensional motion track, tower bending moment, yaw, rotor speed, generator speed, torque, thrust, and load. Each MIMU 18 can sense different types of parameter signals, such as 3D rate of turn signals (Wₓ, W_{y}, W_{z}), 3D acceleration signals (aₓ, a_{y}, a_{z}), 3D earth magnetic field signals (mₓ, m_{y}, m_{z}), and 3D orientation signals (θ, γ, ψ), for example.

In general, the parameter processing unit 19 may be configured to implement any suitable model-based estimation algorithm that may be used to determine parameters of the wind turbine 10 based on the outputs (e.g., orientation angle, displacement and/or acceleration data) provided by the MIMUs 18. For example, the mathematical model used to determine the wind turbine parameters may be physics-based, such as a model based on static mechanics and/or aerodynamic factors. In another embodiment, the mathematical model may be data-driven and may be based on experimental data from the wind turbine 10, such as by using an artificial neural network to determine the wind turbine parameters. Alternatively, the mathematical model may be a combination of both physics-based and data-driven models. Regardless, the mathematical model may be used as a transfer function in order to derive the above mentioned parameters and any other suitable parameters (e.g., tower tilt, tower twisting moment, rotor position, etc.) based on the outputs received from the MIMUs 18.

In several embodiments, a simplified mathematical model of each rotor blade 12 may be stored within the parameter processing unit 19 (e.g., in the form of computer-readable instructions) to allow the processing unit 19 to estimate and/or determine one or more blade-related parameters of the wind turbine 10, such as tip displacement, blade bending moment, blade vibration, blade pitch, blade rotating speed, blade twisting moment, blade deflection curve (i.e., the curvature of a blade due to deflection) and/or the like. For instance, in one embodiment, the rotor blades 12 of the wind turbine 10 may be modeled using a simple, one-dimensional cantilevered beam model in order to determine the tip displacement of each rotor blade 12. In such an embodiment, suitable structural, mechanical and/or geometric parameters of each rotor blade 12, such as the size of each blade 12 (e.g., span and chord measurements), the material properties of each blade 12 (e.g., Young's Modulus, poison's ratio, moment of inertia, stiffness and/or the like), the variation of the flexural rigidity (EI) of each rotor blade 12 along its span and/or the like, may be programmed into the model in order to increase its accuracy. In other embodiments, each rotor blade 12 may be approximated using a more complex mathematical model, such as a two-dimensional or three-dimensional model, which may permit blade-related parameters occurring in more than one dimension (e.g., blade bending moment, blade twisting moment and/or the like) to be determined by the parameter processing unit 19. For example, in one embodiment, a 3D or finite element mathematical model of each rotor blade 12 may be created using suitable modeling software and stored within the parameter processing unit 19. In such an embodiment, the 3D rate of turn, acceleration, magnetic field and/or orientation signals transmitted by the MIMUs 19 may be analyzed using the mathematical model in order to determine the various blade-related parameters of the wind turbine 10. It should be appreciated that similar mathematical models of other components of the wind turbine 10 may be utilized by the parameter processing unit 19 to determine other parameters of the wind turbine 10, such as by utilizing a simple or complex model of the tower 14 to determine any tower-related parameter of the wind turbine 10 (e.g., tower bending moment, tower twisting moment, tower tilt, tower vibration and/or the like).

Additionally, it should be appreciated that the mathematical model utilized by the parameter processing unit 19 may be validated and/or calibrated prior to being stored within the processing unit 19. For instance, in embodiments in which a simplified mathematical model of each rotor blade 12 (e.g., a cantilevered beam model) is used to determine one or more of the blade-related parameters of the wind turbine 10, the model may be validated and/or calibrated using a finite element analysis. Specifically, a finite element model of each rotor blade 12 may be created and analyzed to determine values of one or more of the blade-related parameters of the wind turbine 10 (e.g., tip displacement) at differing wind/load conditions for each rotor blade 12. These values may then be input into the simplified mathematical model in order to calculate the wind/load conditions for each value. Accordingly, by comparing the wind/load conditions calculated using the simplified mathematical model to the actual wind/load conditions applied during the finite element analysis, the mathematical model may be experimentally validated and/or calibrated.

It should also be appreciated that, in addition to including a combination of 3D accelerometers, 3D gyroscopes and/or 3D magnetometers, the disclosed MIMUs 18 may also include one or more temperature sensors configured to measure the temperature at or adjacent to the location of each MIMU 18. Such temperature measurements may then be utilized by the parameter processing unit 19 to further increase the accuracy of the mathematical model. For instance, as is generally understood, the material properties of the various components of the wind turbine 10 (e.g., the rotor blades 12) may vary depending on the operating temperature of the wind turbine 10. Thus, in one embodiment, the computer-readable instructions stored on the parameter processing unit 19 may configure the processing unit 19 to adjust the material properties utilized within the mathematical model based on the temperature measurements provided by the MIMUs 18.

Additionally, it should be appreciated that the output data transmitted by the MIMUs 18 (e.g., in the form sensed parameter signals) may be organized and/or processed by the parameter processing unit 19 using any suitable algorithm. For example, in several embodiments, the parameter signals received from the MIMUs 18 may be organized within a matrix. In detail, during the determining process, the above sensed parameter signals together with a coordinate parameter (xₙ, yₙ, zₙ) of the corresponding MIMU 18 are processed into a vector Tₙ, where “n” stands for the number of MIMU 18. For example, “n” may be 1, 2, 3 . . . , etc. The vector Tₙ can be noted as the following equation:

Tₙ=[W_{x,n} W_{y,n} W_{z,n} a_{x,n} a_{y,n} a_{z,n} m_{x,n} m_{y,n} m_{z,n} θₙ γₙ ψₙ xₙ yₙ zₙ]

Furthermore, the sensed signals from all of the MIMUs 18 can be noted as a matrix S, whose row and column are equal to N and 15 respectively. Wherein, “N” stands for the total number of MIMUs 18, for example N=10. The matrix S can be noted as the following equation:

S=[T₁ . . . T₂ . . . T_{N}]^{T}

There is also a matrix S₀ to denote the initial data of all parameter signals. The matrix S₀ can be determined by processing the data into the matrix S when the wind turbine 10 is in a static status. Subsequently, the real time data in the matrix S and the initial data in the matrix S₀ will be used to determine the mentioned parameters. In other embodiments, the parameters also can be determined by other algorithm processed by the parameter processing unit 19.

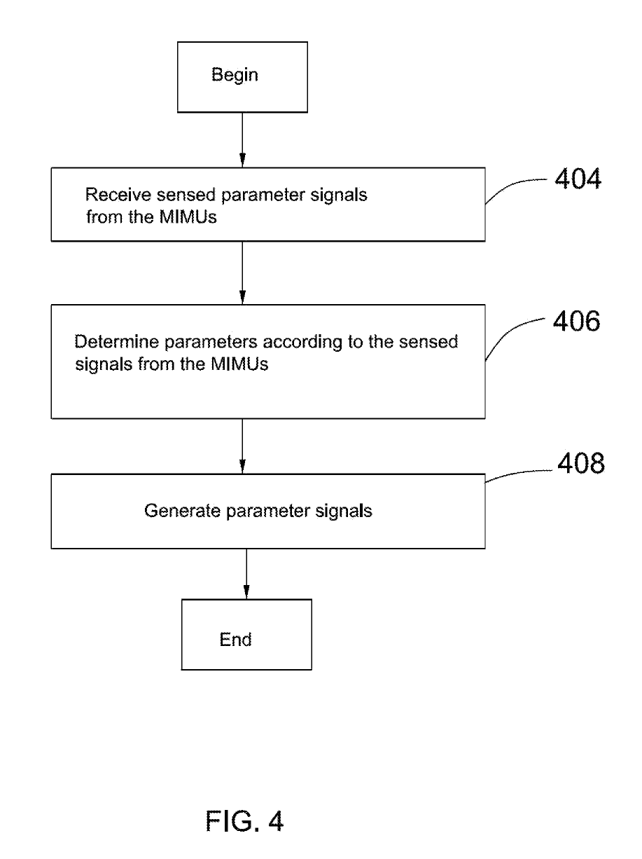

FIG. 4 is a flowchart of one embodiment of a process for determining parameters of the wind turbine 10. In step 404, the sensed parameter signals from the MIMUs 18 are received, for example by the parameter processing unit 19. The parameter processing unit 19 determines the parameters according to the sensed signals from the MIMUs 18 in step 406. In step 408, the parameter processing unit 19 generates parameter signals based on the sensed signals. The parameter signals are monitored by the control unit 21 to control the wind turbine 10 accordingly.

In addition, the present subject matter is also directed to a method for controlling the operation of a wind turbine 10 based on the wind turbine parameters determined using the output signals transmitted from the MIMUs 18. In particular, the real-time monitoring of the wind turbine parameters may allow for the controller 21 to detect undesirable performances and/or operating states of any of the wind turbine components (e.g., blade anomalies, load imbalances, fouling of the blades, ice on the blades, etc.), identify unsafe operating conditions and/or capture any other relevant operational data of the wind turbine 10. Based on such information, the controller 21 may be configured to implement control or corrective actions designed to minimize component damage, increase component efficiency and/or otherwise enhance the overall performance of the wind turbine 10.

For instance, in several embodiments, the controller 21 may be configured to utilize the determined tip displacement of each rotor blade 12 in order to prevent tower strikes and/or otherwise maintain a minimum distance between each rotor blade 12 and the wind turbine tower 14. Specifically, in one embodiment, the controller 21 may be configured to compare the determined tip displacement of each rotor blade 12 to a predetermined tip displacement threshold. In the event that the determined tip displacement for one or more of the rotor blades 12 is equal to or exceeds the predetermined tip displacement threshold, the controller 21 may be configured to implement a corrective action in order to reduce or otherwise control tip deflection.

It should be appreciated that the corrective action performed by the controller 21 may form all or part of any suitable mitigation strategy designed to reduce or otherwise control tip deflection. For example, in one embodiment, the corrective action may include controlling the pitch angle of one or more of the rotor blades 12, such as by pitching one or more of the rotor blades 12 for a partial or full revolution of the rotor, to permit the loads acting on the rotor blades 12 to be reduced or otherwise controlled. As is generally understood, the pitch angle of each rotor blade 12 may be adjusted by controlling a pitch adjustment mechanism 222 coupled to each rotor blade 12 via a pitch bearing (not shown). For example, as shown in FIG. 8, pitch adjustment mechanisms 222 (one of which is shown) may be disposed within the hub 11 adjacent to the location at which each rotor blade 12 is coupled to the hub 11, thereby permitting each pitch adjustment mechanism 222 to rotate its corresponding rotor blade 12 about the blade's longitudinal or pitch axis. In addition, the pitch adjustment mechanisms 222 may be communicatively coupled to the controller 21, either directly or indirectly (e.g., through a pitch controller (not shown)), such that suitable control signals may be transmitted from the controller 21 to each pitch adjustment mechanism 222. Accordingly, the pitch adjustment mechanisms 222 may be controlled by the controller 21 either individually or collectively in order to permit selective adjustment of the pitch angle of each rotor blade 12.

In another embodiment, the corrective action may comprise modifying the blade loading on the wind turbine 10 by increasing the torque demand on a generator 224 (FIG. 8) of the wind turbine positioned within the nacelle 13. In general, the toque demand on the generator 224 may be modified using any suitable method, process, structure and/or means known in the art. For instance, in one embodiment, the torque demand on the generator 224 may be controlled using the turbine controller 21 by transmitting a suitable control signal/command to the generator 224 in order to modulate the magnetic flux produced within the generator 224 As is generally understood, by modifying the torque demand on the generator 224, the rotational speed of the rotor blades may be reduced, thereby reducing the aerodynamic loads acting on the blades 12.

In a further embodiment, the corrective action may include yawing the nacelle 13 to change the angle of the nacelle 13 relative to the direction of the wind. In particular, as shown in FIG. 8, the wind turbine 10 may include one or more yaw drive mechanisms 226 communicatively coupled to the controller 21, with each yaw drive mechanism(s) 226 being configured to change the angle of the nacelle 12 relative to the wind (e.g., by engaging a yaw bearing 228 (also referred to as a slewring or tower ring gear) of the wind turbine 10). As is generally understood, the angle of the nacelle 13 may be adjusted such that the rotor blades 12 are properly angled with respect to the prevailing wind, thereby reducing the loads acting on the blades 12. For example, yawing the nacelle 13 such that the leading edge of each rotor blade 12 points upwind may reduce loading on the blades 12 as they pass the tower 14.

In other embodiments, the corrective action may comprise any other suitable control action that may be utilized to reduce the rotational speed of the rotor blades 12 and/or otherwise reduce the amount of loads acting on the blades 12. For example, in embodiments in which a wind turbine 10 includes one or more mechanical brakes (not shown), the controller 21 may be configured to actuate the brake(s) in order to reduce the rotational speed of the rotor blades 12, thereby reducing loading on the blades 12. In even further embodiments, the displacement of each rotor blade 12 may be controlled by performing a combination of two or more corrective actions, such as by altering the pitch angle of one or more of the rotor blades 12 together with yawing the nacelle 13 or by modifying the torque demand on the generator 224 together with altering the pitch angle of one or more of the rotor blades 12.

It should be appreciated that, by providing the capability to monitor and control the tip deflection of each rotor blade 12 in real-time, the present subject matter may allow for longer rotor blades 12 to be installed on wind turbines 10, thereby increasing the annual energy production (AEP) and overall efficiency of such wind turbines 10. In particular, the controller 21 to may be configured to accommodate the increased loads that may occur as a result of longer rotor blades 12 by implementing suitable corrective actions in response to excessive tip displacements. As such, new rotor blades 12 may be manufactured with an increased length or span without increasing the likelihood of a tower strike. Moreover, the present subject matter may allow for wind turbines 10 with extended blades (e.g., rotor blades 12 having blade or tip extensions installed thereon) to operate in increased load conditions without significantly increasing the tip deflection of the rotor blades 12.

It should also be appreciated that the controller 21 may also be configured to perform one or more control or corrective actions to account for and/or adjust various other operating parameters and/or conditions of a wind turbine 10. For example, in one embodiment, the output signals provided by the MIMUs 18 may allow for the detection of asymmetric loading on the rotor blades 12, such as load imbalances due to wind shear/gradient and/or yaw misalignment. In such case, the controller 21 may be configured to adjust the pitch angle of one or more of the rotor blades 12, yaw the nacelle 13 and/or perform any other suitable corrective action that may be necessary to correct the load imbalance. In another embodiment, the output signals provided by the MIMUs 18 may allow for the detection of fouling, ice and/or damage on one or more of the rotor blades 12. For example, blade vibration data provided by the 3D accelerometers of the MIMUs 18 may allow for fouling, ice and/or damage detection. Accordingly, the controller 21 may be configured to perform an appropriate action to account for such foiling/ice/damage, such as by controlling an automatic cleaning/deicing system of the wind turbine 10 in order to clean/device the rotor blades 12 or by shutting down the wind turbine 10 to allow removal of the fouling and/or ice and/or repair to the rotor blades 12. In a further embodiment, the output signals provided by the MIMUs 18 may allow for an accurate estimate of the angle of the nacelle 13 relative to the wind direction. As such, the controller 21 may be configured to yaw the nacelle 13 to ensure that the nacelle 13 is appropriately oriented relative to the wind, thereby improving the overall efficiency of the wind turbine 10.

Additionally, it should be appreciated that, in alternative embodiments, the disclosed wind turbine 10 need not include a separate parameter processing unit 19 for receiving/processing the sensed parameter signals originating from the MIMUs 18 in order to determine the operating parameters of the wind turbine 10. For example, in one embodiment, the MIMUs 18 may be directly coupled to the controller 21 such that the sensed parameter signals are transmitted straight to the controller 21. In such an embodiment, the controller 21 may be configured to both receive/process the sensed parameter signals to determine the operating parameters of the wind turbine 10 and utilize such parameters to control the operation of the wind turbine 10.

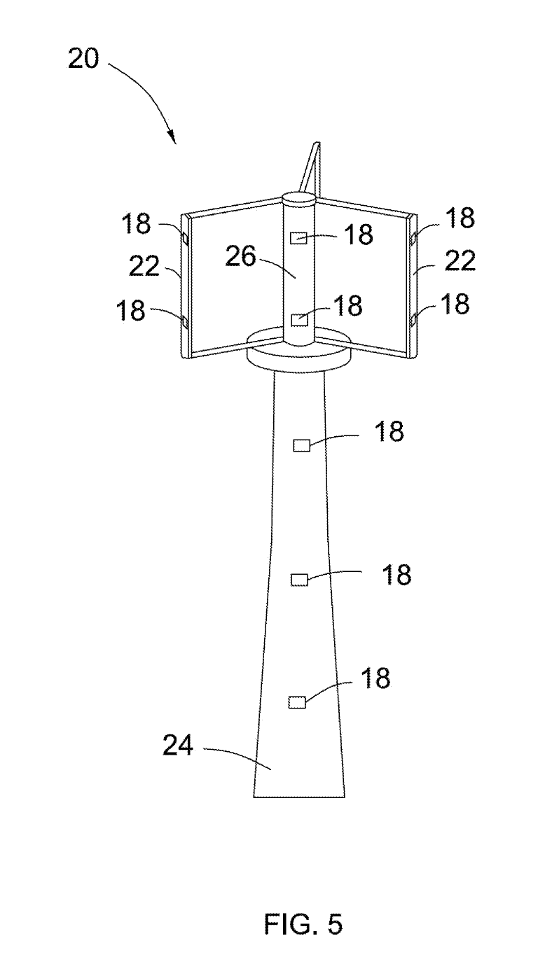

In FIGS. 1 and 2, the illustrated wind turbine 10 is a horizontal axis type wind turbine 10. However, embodiments of the invention can also be utilized in any other type of wind turbines. For example, FIG. 5 illustrates another type (vertical axis type) of wind turbine 20. The wind turbine 20 in this embodiment includes eleven MIMUs 18 mounted on different parts of the wind turbine 20. For example, each blade 22 includes two MIMUs 18, the tower 24 includes three MIMUs 18, and the main shaft 26 includes two MIMUs 18. The difference between the wind turbine 10 and the wind turbine 20 is the number and the mounted position of the MIMUs 18, which is decided by the type, size, or other characteristics of the wind turbines 10 and 20.

In the embodiments disclosed herein, MIMUs 18 are utilized to monitor different parameters of different parts of the wind turbines 10 and 20, which makes the parameter monitoring system simpler, cost efficient, and comprehensive.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for determining parameters of a wind turbine, the method comprising:
receiving signals from at least one Micro Inertial Measurement Unit (MIMU) mounted on or within a component of the wind turbine; and,
determining at least one parameter of the wind turbine based on the signals received from the at least one MIMU.

2. The method of claim 1, wherein receiving signals from at least one MIMU mounted on or within a component of the wind turbine comprises receiving signals from at least one MIMU mounted on or within at least one of a tower, a nacelle, a hub, a shaft and a rotor blade of the wind turbine.

3. The method of claim 1, wherein determining at least one parameter of the wind turbine based on the signals received from the at least one MIMU comprises determining at least one of blade pitch, blade rotating speed, structural vibration, blade bending moment, blade twisting moment, tip displacement, three dimensional motion track, tower bending moment, yaw, rotor speed, generator speed, torque, thrust, load, tower tilt and rotor position.

4. The method of claim 1, wherein determining at least one parameter of the wind turbine based on the signals received from the at least one MIMU comprises determining with a processing unit at least one parameter of the wind turbine based on the signals received from the at least one MIMU using a model-based estimation algorithm.

5. The method of claim 4, wherein the model-based estimation algorithm comprises at least one of a physics based mathematical model or a data-driven mathematical model.

6. The method of claim 1, further comprising controlling operation of the wind turbine based on the at least one parameter.

7. The method of claim 6, wherein controlling operation of the wind turbine based on the at least one parameter comprises pitching at least one rotor blade of the wind turbine based on the at least one parameter.

8. The method of claim 6, wherein controlling operation of the wind turbine based on the at least one parameter comprises adjusting a torque demand on a generator of the wind turbine based on the at least one parameter.

9. The method of claim 6, wherein controlling operation of the wind turbine based on the at least one parameter comprises yawing a nacelle of the wind turbine based on the at least one parameter.

10. The method of claim 6, wherein controlling operation of the wind turbine based on the at least one parameter comprises at least one of reducing a rotational speed of the wind turbine, activating a mechanical brake of the wind turbine, shutting down the wind turbine and activating an automatic cleaning or de-icing system of the wind turbine.

11. A method for determining tip displacement of a wind turbine, the method comprising:
receiving signals from at least one Micro Inertial Measurement Unit (MIMU) mounted on or within at least one rotor blade of the wind turbine; and,
determining a tip displacement of the at least one rotor blade based on the signals received from the at least one MIMU.

12. The method of claim 11, wherein receiving signals from at least one MIMU mounted on or within at least one rotor blade of the wind turbine comprises receiving signals from a first MIMU mounted on or within the at least one rotor blade at or adjacent to a blade root of the at least one rotor blade and receiving signals from a second MIMU mounted on or within the at least one rotor blade at or adjacent to a middle portion or a blade tip of the at least one rotor blade.

13. The method of claim 11, further comprising controlling operation of the wind turbine based on the tip displacement of the at least one rotor blade.

14. The method of claim 13, wherein controlling operation of the wind turbine based on the tip displacement of the at least one rotor blade comprises at least one of pitching the at least one rotor blade, adjusting a torque demand on a generator of the wind turbine, yawing a nacelle of the wind turbine and reducing a rotational speed of the wind turbine in order to adjust the tip displacement.

15. A wind turbine, comprising:
a tower;
a nacelle mounted on top of the tower;
a rotor coupled to the nacelle, the rotor including a shaft, a hub and a plurality of blades extending from the hub; and,
at least one Micro Inertial Measurement Unit (MIMU) mounted on or within at least one of the tower, the nacelle, the hub, the shaft and the plurality of rotor blades, the at least one MIMU being configured to sense at least one parameter of the wind turbine.

16. The wind turbine of claim 15, further comprising a processing unit configured to receive signals associated with the at least one parameter from the at least one MIMU, the processing unit being configured to determine the at least one parameter based on the signals received from the at least one MIMU.

17. The wind turbine of claim 15, wherein the at least one parameter comprises at least one of blade pitch, blade rotating speed, structural vibration, blade bending moment, blade twisting moment, tip displacement, three dimensional motion track, tower bending moment, yaw, rotor speed, generator speed, torque, thrust, load, tower tilt and rotor position.

18. The wind turbine of claim 15, further comprising a plurality of MIMUs, at least two of the plurality of MIMUs being mounted on or within each of the plurality of rotor blades.

19. The wind turbine of claim 18, wherein a first sensor of the plurality of MIMUs is mounted at or adjacent to a blade root of the rotor blade and a second sensor of the plurality of MIMUs is mounted at or adjacent to a blade tip of the rotor blade.

20. The wind turbine of claim 18, wherein a first sensor of the plurality of MIMUs is mounted at or adjacent to a blade root of the rotor blade and a second sensor of the plurality of MIMUs is mounted at or adjacent to a middle portion of the rotor blade.
